(19) United States
(12) Patent Application Publication
(10) Pub. No.: US 2006/0135341 A1
(43) Pub. Date: Jun. 22, 2006

(54) B-quartz glass-ceramic extreme ultraviolet optical elements and a method of making them

(76) Inventors: Adam J. Ellison, Painted Post, NY (US); Philip M. Fenn, Corning, NY (US)

Correspondence Address: CORNING INCORPORATED, SP-TI-3-1, CORNING, NY, 14831, US

(21) Appl. No.: 11/016,066

(22) Filed: Dec. 17, 2004

(51) Int. Cl. C03C 10/14; C03C 10/12

(52) U.S. Cl. 501/4; 501/7

(57) ABSTRACT

The invention is directed to a glass-ceramic material suitable for use in the manufacturing of EUVL reflective optics. The glass-ceramic materials is made from a composition that comprises (in wt. %): SiO₂=64-70; Al₂O₃=18-24; Li₂O=1.6-3.8; MgO=0.8-1.5; ZnO=0.7-4.2; BaO=0.1-1.4; TiO₂=2.0-3.5; ZrO₂=1.25-2.5; As₂O₃=0.1-1.0; Na₂O<0.5; and K₂O<0.5; and the glass-ceramic material has an aggregate coefficient of thermal expansion of ±1 ppm/° C. (±0.1×10⁻⁷/° C.) in the temperature range 0-200° C.

### FIELD OF THE INVENTION

The invention is directed to glass and glass-ceramic materials suitable for use as substrates in extreme ultraviolet lithographic methods; and in particular to a glass or glass-ceramic material having a near-zero coefficient of thermal expansion and a near-zero coefficient of thermal expansion slope.

### BACKGROUND OF THE INVENTION

Advances in shrinking the size and reducing the electrical power requirements of electronic equipment while increasing the equipment's operational speed, processing power, range, and overall quality is dependent on the size of the transistors, the circuitry and other elements the semiconductor industry has been able to form in an integrated circuit pattern on a single chip. For example, several decades ago it required a room full of electronic equipment to perform the same functions performed by desktop or laptop computers available in 2004. In mobile telephony the equipment was the size of a large hardbound novel and performed fewer functions than today's palm-sized cell phones. These and other advances in electronics have occurred because component manufacturers have been continuously able to shrink the size of the transistors, the circuitry and other elements used in electronic equipment. The ability to perform such shrinkage is due to the use of lithographic methods which are basically a photographic technique that allows more and more features to be placed on a single chip without increasing the size of the chip. In the lithographic process light is directed onto a mask (a stencil of an integrated circuit pattern) and the mask image is projected onto a semiconductor wafer coated with a light sensitive photoresist material. In order to increase the density of elements in an integrated circuit the features of the elements must decrease without sacrificing performance. This requires the use of shorter and shorter wavelengths of light.

In the late 1990s the semiconductor industry was using 248 nanometer (“nm”) wavelengths to print 120-150 nm features on semiconductor chips. This process is being replaced by lithographic systems using 193 nm and 157 nm wavelengths (deep ultraviolet range) to make chips with elements in the 100-120 nm range. To make semiconductor chips with even smaller features will require the use of light in the extreme ultraviolet (“EUV”) range below approximately 120 nm. However, the use of EUV range light gives rise to a serious problem because the materials used for lenses in the 248, 193 and 157 nm lithographic systems absorb radiation in the EUV range instead of transmitting it. The result: no transmitted light and hence no image formed on the semiconductor wafer.

Extreme ultraviolet lithography (“EUVL”) utilizing radiation below approximately 120 nm will require a method that is completely different from that using 248, 193 and 157 radiation. For lithographic processes using 248 and 193 nm radiation, optical elements such stepper lenses could be made from very pure fused silica. At 157 nm the fused silica elements must be replaced by elements made from Group IIA alkaline earth metal fluorides, for example, calcium fluoride, because of absorption by silica at 157 nm. For the EUVL operating at approximately 120 nm or less, no isotropic materials exist that are transparent at these very short wavelengths. As a result, reflective optics must be used instead of conventional focusing optics. Reflective optics for EUVL are made by polishing the surface a substrate material such as silicon or glass to achieve the minimum degree of surface roughness; a proposed EUVL specification for roughness being on the order of <0.3 nm rms over a 10 mm spacing, with an eye toward a preferred specification of <0.2 nm rms over a 10 μm spacing. Multiples layers of reflective coating materials such as Mo/Be and Mo/Si are deposited on the substrate by magnetron sputtering or other suitable technique.

In a EUVL process the expansion/contraction properties of the reflective optics must be carefully controlled because of the very short wavelengths involved. In particular, it is critically important that the temperature sensitivity of the coefficient of thermal expansion (“CTE”) be kept as low as possible, and that the rate of change of the CTE with temperature be as low as possible in the normal operating temperature range of the lithographic process which is in a general range of 4-40° C., preferable 20-25° C., with approximately 22° C. being the target temperature. At the present there are only two commercially available materials suitable for use as the substrate for reflectance optics that will satisfy both constraints. These are ULE® (Coming Incorporated, Coming, N.Y.) and ZERODUR® (Schott A G, Mainz, Germany). While both are low expansion materials, ULE, a single-phase glass material that is easy to polish, but costly to produce. ULE has a technical edge over ZERODUR in that the deliberate mixture of glass and crystal in ZERODUR (which is thus a two-phase material) makes it difficult to obtain a polish of the type required for this application. Consequently, in order for development of EUVL using reflective optics to proceed, what is needed a material with a CTE and d(CTE)/dT (the CTE slope) comparable or better than either ULE or Zerodur, but as nearly as possible single-phase in order to produce a fine surface finish. The present invention describes a nearly single-phase glass-ceramic material with near-zero CTE and near-zero CTE slope that is suitable for use as the substrate for EUVL reflectance optics and method a method for making this material.

### SUMMARY OF THE INVENTION

In one aspect the invention is directed to a nearly single-phase β-quartz glass-ceramic material with a near-zero CTE and near-zero CTE slope in the temperature range 0-200° C.

In another aspect the invention is directed to a glass-ceramic material suitable for use in the manufacturing of EUVL reflective optics, said glass-ceramic being made from a composition comprising (in wt. %):
SiO₂ 64-70
Al₂O₃ 18-24
Li₂O 1.6-3.8
MgO 0.8-1.5
ZnO 0.7-4.2
BaO 0-1.4
TiO₂ 2.0-3.5
ZrO₂ 1.25-2.5
As₂O₃ 0-1.0
Na₂O <0.5
K₂O <0.5

wherein said glass-ceramic material has an aggregate coefficient of thermal expansion of ±1 ppm/° C. (±0.1×10⁻⁷/° C.) in the temperature range 0-200° C.

In another aspect the invention is directed to a method for making a nearly single phase P-quartz glass-ceramic material with a near-zero CTE and near-zero CTE slope in the temperature range 0-200° C. In one embodiment the method of the invention includes a firing schedule as follows. The starting temperature for the method is in the range of 18-50° C. Subsequent temperature ranges, ramp rates and hold times are shown in Table 1, the General Firing Schedule. Glass-ceramics of the compositions given above and prepared by firing according to the General Firing Schedule are suitable for use as a substrate for EUVL reflective optics.

TABLE 1
General Firing Schedule

| Starting Temp | Final Temp | ramp rate | Hold Time |
|---|---|---|---|
| (° C.) | (° C.) | (° C./minute) | (Hours) |
| 22 ± 5 | 720 ± 20 | 0.5 | ≧4 to 8 |
| 720 ± 20 | 820 ± 20 | 1 | ≧4 to 40 |
| 820 ± 20 | T | 0.1-0.05 | 0 |
| T | 22 | 0.2 | end |

Where T = 700 ± 30° C.

### BRIEF DESCRIPTION OF THE DRAWINGS

FIG. 1 illustrates thermal expansion Delta L/L (also written as “ΔL/L”) at various temperatures for a Corning 9600 commercial glass cerammed according to the present invention

FIG. 2 illustrates the thermal expansion Delta L/L for a composition of U.S. Pat. No. 4,707,458 cerammed according to the present invention.

FIG. 3 illustrates the thermal expansion Delta L/L for a composition of U.S. Pat. No. 5,070,045 cerammed according to the present invention.

FIG. 4 illustrates the average CTE for composition of FIG. 4.

FIG. 5 represents the microprobe analysis of the SiO₂ concentration through the thickness of a cerammed composition of FIG. 3.

### DETAILED DESCRIPTION OF THE INVENTION

In this specification the term “nearly single-phase glass-ceramic substrate” is used. This term is to be further understood as indicating that the materials of the invention approaches a total relaxation (that is, near 100% relaxation) of the spatial and tensile relationships between crystals and between crystals and glasses. This near-total relaxation enables one to achieve a high degree of surface smoothness when the material is polished for EELU applications. The present invention is found to be the best method to-date to produce uniform small crystals in compositions such as indicated herein in order to achieve nearly 100% relaxation.

Beta-quartz glass-ceramics have been known for nearly 40 years. They are commonly used in consumer product applications where high thermal shock resistance is of value: for example, VISIONS™ cookware and EUROKERA™ stovetops which are made of a material (subsequently trademarked by a Corning Incorporated subsidiary as “KERALITE™”) as described in U.S. Pat. No. 5,070,045. The cookware products are able to move from the freezer to a hot oven without risk of cracking due to their low thermal expansion and the stovetop products are able to withstand the “high heat” setting one finds on conventional electric and gas stoves. This low thermal expansion is an artifact of random orientation of the product's small crystals that have a relatively large and positive CTE along one crystallographic axis (c) and a negative CTE along the perpendicular axes (a). Random orientation means that a crystal expanding along one external coordinate will be matched elsewhere by a crystal undergoing contraction along the same external coordinate. This leads to an aggregate expansion that is approximately
CTE(bulk)=CTE(c)+2CTE(a), (1)
where CTE(c) and CTE(a) refer to the coefficients of thermal expansion along the c- and a-axis directions. Provided that Eq. (1) sums to zero, and that no secondary phase is present, then one will obtain a ceramic with zero expansion. If there is a secondary phase, such as residual glass, then CTE(bulk) is approximately as follows:
CTE(bulk)=V_{c}[CTE(c)+2CTE(a)]+VₚCTE(p), (2)

where V_{c} is the volume fraction of the crystal and Vₚ is the volume fraction of the glass. Most glasses have positive coefficients of thermal expansion through the temperature range of interest, necessitating an aggregate negative expansion for the crystal contribution. This is, in fact, the basis for the ZERODUR material containing a modest fraction of glass.

If for EUVL uses thermal expansion were the only criterion, then the means by which one obtains zero expansion (that is, having either one crystal or crystal+glass) would be irrelevant. However, for use a substrate for EUV reflective optics, it is necessary that the substrate material be polished to an extraordinary level of surface smoothness prior to the application of the layers of reflective materials. It is well known to those skilled in the art that the mechanical properties of crystals are different from those of glasses, even if the glasses and crystals have identical chemical compositions. For example, the Moh hardness of the room-temperature crystalline polymorph of silica, α-quartz, is approximately 7, whereas the Moh hardness of silica glass is approximately 5. When a composite of α-quartz and vitreous silica (v-SiO₂) is subjected to polishing grit, the silica glass is eroded more quickly than the crystal material. This results in variations in surface height as one moves from glass to crystal. While there are means for reducing the magnitude of these differences, it is extremely difficult in a multiphase material to obtain the same level of surface roughness that one can obtain from a single-phase material. Stated in another way, one cannot obtain the same degree of smoothness with a two-phase material such as a glass/crystal material as one can with an one-phase material of crystal or glass only. Therefore, in order to obtain a near-zero expansion ceramic from a green glass precursor, it is highly desirable that as nearly as possible the ceramic be entirely crystalline; that is, as nearly single phase crystalline as possible.

Ceramics can be produced by methods other than ceramming a green glass, for example, slip-casting a particulate form of a crystal into near final form, and congealing the particles into a solid through incorporation of a binder. However, by this and other conventional ceramming processes, it is extraordinarily difficult to obtain polycrystalline ceramics with 100% theoretical density and truly random crystallographic orientation. At less than 100% theoretical density, voids will be present that preclude the possibility of obtaining a smooth surface such as is required for EUVL reflective optics. At 100% theoretical density, but with other than random orientation, one obtains a ceramic material that has an anisotropic expansion; that is, the expansion is greater in one dimension and less in another dimension. Consequently, the traditional methods for obtaining dense ceramic materials are not suited for making EUV or any other kind of reflective optics because the material will expand differently in different directions.

Chemical compositions suitable for making the green glass (a term of art meaning a composition intended for further processing into a final product; in this case a glass composition that will be converted into a glass-ceramic) used for making the near-zero CTE and near-zero CTE slope glass-ceramic according to the present invention are described in U.S. Pat. No. 4,707,458 (ring laser gyros) and U.S. Pat. No. 5,070,045 (stove-top glass-ceramics ); except that any coloring agents described in these patents, for example, V₂O₅ and Cr₂O₃, are not necessary for a composition intended for EUVL use. In this invention it has been determined that the final CTE characteristics of the material for EUVL application is insensitive to the identity of the green glass provided that the green glass falls within the composition ranges of these two patents and that it is cerammed according to the schedule given herein. In accordance with the invention, the combination of these two criteria results in a cerammed material suitable for EUVL that has a CTE in the temperature range of 0-200° C. of 0±0.5×10⁻⁷/° C. This can be compared to the CTE value 0±3×10⁻⁷/° C., and higher, reported in U.S. Pat. Nos. 4,707,458 and 5,070,045. The method of the present invention results in a cerammed material having a significantly lower CTE value/range over the prior art. The need for tight control on the CTE is important because variations in the size of the reflecting surface affect focal distance. It is equally important that it is possible to tune the CTE slope vs. temperature so that the point where the slope goes to zero is close to the operating temperature of EUV reflective optics. A near-zero rate of change of CTE means that over a narrow temperature range the CTE, whatever its value, is approximately unchanged within a change of temperature in the range of ±2-3° C. of the starting point temperature. Mathematically,
d(CTE)/dT=d²(ΔL/L)/d²T≈0

where d(CTE) is the derivative of change in CTE; dT is the derivative of the change in temperature; T is temperature; d² is a second derivative; and ΔL/L in the change in length (ΔL) over the initial length (L).

The compositions used in making the green glass for use in producing cerammed material suitable to use as a substrate for EUVL reflective optics are (in wt. %):
SiO₂ 64-70
Al₂O₃ 18-24
Li₂O 1.6-3.8
MgO 0.8-1.5
ZnO 0.7-4.2
BaO 0-1.4
TiO₂ 2.0-3.5
ZrO₂ 1.25-2.5
As₂O₃ 0-1.0
Na₂O <0.5
K₂O <0.5

While the source materials for the above is not important, but would typically be simple oxides for SiO₂, Al₂O₃, MgO, ZnO, TiO₂, ZrO₂, carbonates or nitrates for Li₂O and BaO, and oxides or arsenic acid for As₂O₃. Ba is present to reduce scattering of transmitted light when the ceramic is produced through a very brief ceram schedule, and it is not necessary to obtain a low CTE. Na and K are present as contaminants from naturally-occurring batch materials, and eliminating them has either no effect or a slightly positive impact on the final CTE.

The present invention takes advantage and improves glass-ceramic technology to create a final cerammed body consisting almost entirely of crystals at 100% theoretical density. In the present invention the crystals are extremely small and randomly oriented, thus assuring an isotropic coefficient of thermal expansion. The compositions of the crystals are selected so as to produce an aggregate expansion for the dense, cerammed body that is 0±1 ppm/° C. at temperatures in the range of 0 and 200° C. The ceramming schedule according to the invention is selected so as to produce a very large number of nuclei, then, as nearly as possible, exhaust most of the residual glass as crystalline components grow from it, thus producing a mostly crystalline material with 100% theoretical density. The heat-up and cool-down rates are selected so as to minimize any residual stress caused by transforming the initially moderately-high CTE green glass into a near-zero CTE glass-ceramic. This is critical for successfully polishing the cerammed body into a substrate that can be used to make a EUV reflectance optic. The cerammed material resulting from practicing the invention is a nearly single phase quartz glass-ceramic material with a near-zero CTE and near-zero CTE slope in the temperature range 0-200° C. The CTE of the product of the invention is 0±0.5×10⁻⁷/° C. and the CTE slope is approximately 0.0 at 22° C.

In practicing the method of the invention to produce a cerammed material suitable for EUVL reflective optics, a slow ramp rate on heating is important to maintain the integrity of large ceramic objects; for example, 20 cm square plates that are 1-2 cm in thickness. (The maximum dimensions currently envisioned for EUVL reflective optics is approximately 15 cm square by 1.5 cm thick. The extra size is needed to allow for cutting and polishing the sample.) In accordance with the invention it has been determined that a ramp rate of no more than 1° C. per minute is sufficient to preserve the integrity of parts as large as 25 cm square and 4 cm thick, and provides a 100% yields for products having the foregoing dimensions and/or smaller parts.

A long nucleation hold at relatively low temperature is also critical to ensure the formation of a large number of very small nuclei. Without this, a comparatively small number of large crystals grow within a matrix of smaller crystals that nucleate and grow at higher temperature. This can produce a large amount of stress in the final part.

In addition, a very long hold at a very low crystal growth temperature is important to ensure that nearly all of the green glass is consumed and converted to crystals, and that residual stresses are kept to a minimum. The use of high ceramming temperatures can cause a large exotherm as glass is converted to crystal, which in turn can produce enough stress to cause the part to fail.

Finally, a slow ramp-down from the growth temperature is important for obtaining the lowest CTE possible from a particular green glass composition. A slow ramp to below the nucleation temperature is also important for keeping residual stress at a minimum.

The General Firing Schedule for practicing the ceramming method of the invention is shown in the following Table 1.

TABLE 1
General Firing Schedule

| Starting Temp | Final Temp | ramp rate | Hold Time |
|---|---|---|---|
| (° C.) | (° C.) | (° C./minute) | (Hours) |
| 18-50 | 720 ± 20 | 0.5 | ≧4 to 8 |
| 720 ± 20 | 820 ± 20 | 1 | ≧4 to 40 |
| 820 ± 20 | T | 0.1-0.05 | 0 |
| T | 22 | 0.2 | end |

Where T = 700 ± 30° C.

Times and temperatures within the parameters of the General Schedule can be used in practicing the invention as will be illustrated in the subsequent Examples.

### EXAMPLE 1

In this Example 1 a composition from U.S. Pat. No. 4,707,458 was fired in accordance with the invention to create a new cerammed product having a near-zero CTE and a near-zero CTE slope.

A 3 kg powder batch is prepared of the following composition (in wt. %):
SiO₂ 65.49±0.5
Al₂O₃ 21.57±0.3
Li₂O 3.33±0.2
MgO 1.27±0.1
ZnO 1.57±0.2
BaO 0.81±0.1
TiO₂ 2.68±0.3
ZrO₂ 1.69±0.3
As₂O₃ 0.99±0.1

While the source materials for the above is not important, but would typically be simple oxides for SiO₂, Al₂O₃, MgO, ZnO, TiO₂, ZrO₂, As2O₃, and carbonates or nitrates for Li₂O and BaO. The batch is ball-milled in a ceramic mill for 1 hour, and then transferred to an 1800 cc platinum crucible. The crucible is placed in a furnace at 1550° C., held at temperature for about 16 hours, then ramped at approximately 50° C./hr to 1650° C., held for 4 hours, then poured into a square steel frame about 20 cm wide by 2 cm deep. Once the glass sets up, it is transferred to an annealer at 650° C., held for 1 hour, and then slowly cooled to room temperature. The square place of glass is transferred to a ceramming furnace and subjected to the firing schedule shown in Table 2 which is in accord with the times and temperatures shown in the Table 1 General Firing Schedule.

TABLE 2
Firing Schedule for Example 1

| Starting Temp. | Final Temp | ramp rate | |
|---|---|---|---|
| (° C.) | (° C.) | (° C./minute) | Hold (hours) |
| 22 | 720 | 0.5 | 4 |
| 720 | 820 | 1 | 20 |
| 820 | T = 720 | 0.1 | 0 |
| 720 | 22 | 0.2 | End |

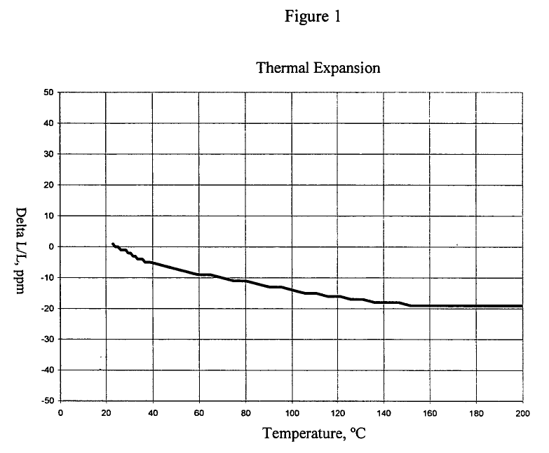

Once cooled, the cerammed body is removed, cut to shape and polished. The ΔL/L vs. T curve for the ceramic is shown in FIG. 1. FIG. 1 shows the relative flattening of ΔL/L versus temperature. Minor adjustments of the T value in the General Firing Schedule will flatten the curve, For example, the sample were fired with a General Firing Schedule T value of 680° C., changing the T value to 700° C. would flatten the curve. In this Example 1, curve flattening would be achieved by increasing the T value to a temperature in the range of 710-720° C. In addition, the curve can be flattened by a slight increase in the amount of magnesium (“Mg”) or lithium (“Li”) contained in the green glass composition. Typically the Mg of Li increase is in the range of 5-15% of the amount in the initial green glass composition. In the green glass composition of this Example 1 the amount of MgO is 1.27 wt. %. To flatten the curve this would be increased to a value in the range of 1.330-1.46 wt. %. Alternatively, lithium could be increased or one could also increase both Mg and Li. The other components of the green glass composition would remain unchanged from the their initial values, though obviously their wt. % values in the new composition would be slightly different and would have to be recalculated so that the total adds up to 100%.

### EXAMPLE 2

In this Example 1 a composition from U.S. Pat. No. 4,707,458 was fired in accordance with the invention to create a new cerammed product having a near-zero CTE and a Near-zero CTE slope.

A 3 kg powder batch is prepared of the following composition (in wt. %):
SiO₂ 65.13±0.5
Al₂O₃ 21.37±0.3
Li₂O 2.89±0.2
MgO 1.14±0.1
ZnO 2.95±2
BaO 0.81±0.1
TiO₂ 2.68±0.3
ZrO₂ 1.69±0.5
As₂O₃ 0.78±0.1

While the source materials for the above is not important, but would typically be simple oxides for SiO₂, Al₂O₃, MgO, ZnO, TiO₂ and ZrO₂, As2O₃, and carbonates or nitrates for Li₂O and BaO. It differs from that of Example 1 in that it has lower Li₂O, slightly lower MgO and higher ZnO. This means that if it were completely converted to a single crystal composition, the crystal composition would be intrinsically different than that produced by the green glass in Example 1.

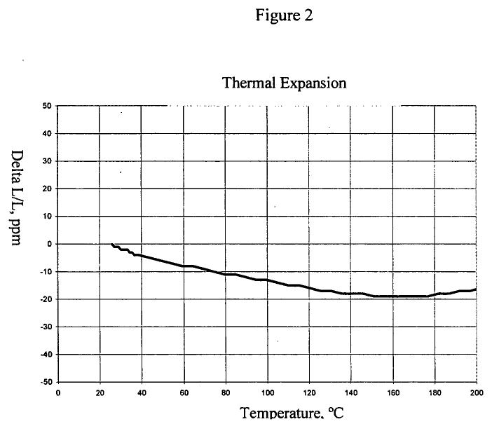

The batch is ball-milled in a ceramic mill for 1 hour and then transferred to an 1800 cc platinum crucible. The crucible is placed in a furnace at 1550° C., held at temperature for about 16 hours, then ramped at approximately 50° C./hr to 1650° C., held for 4 hours, then poured into a square steel frame about 20 cm wide by 2 cm deep. Once the glass sets up, it is transferred to an annealer at 650° C., held for 1 hour, then slowly cooled to room temperature. The square place of glass is transferred to a ceramming furnace and subjected to the heat treatment described in Example 1, Table 2. Once cooled, the cerammed body is removed, cut to shape and polished. The □L/L vs. T curve for the ceramic is shown in FIG. 2.

### EXAMPLE 3

In this Example 1 a composition from U.S. Pat. No. 5,070,045 was fired in accordance with the invention to create a new cerammed product having a near-zero CTE and a near-zero CTE slope.

A 3 kg powder batch is prepared of the following composition (in wt. %):
SiO₂ 67.60±0.5
Al₂O₃ 19.85±0.3
Li₂O 3.45±0.2
MgO 1.22±0.1
ZnO 1.66±0.2
BaO 0.80±0.1
TiO₂ 2.60±0.3
ZrO₂ 1.68±0.5
Na₂O* 0.17
K₂O* 0.19
As₂O₃* 0.79±0.1

(*=Na and K are tramp materials from the Li source)

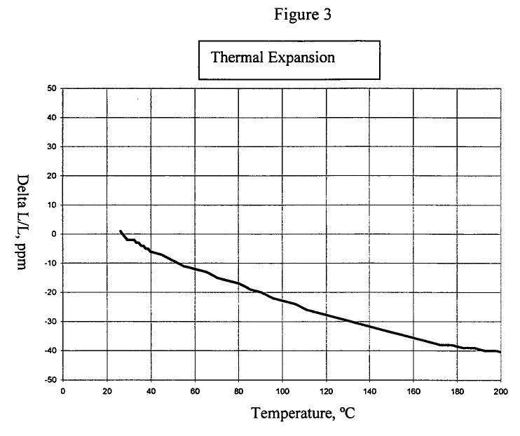

This composition lies within the range of compositions given in U.S. Pat. No. 5,070,045, and is the target composition for KERALITE, one of Corning's products for Eurokera applications. Aside from low concentrations of Na and K to improve melting, it differs from the composition in Example 1 in that SiO₂ is increased at the expense of Al₂O₃. As with Example 2, this means that if it were completely converted to a single crystal composition, the crystal composition would be intrinsically different than that produced by the green glass in Examples 1 or 2. The batch is ball-milled in a ceramic mill for 1 hour, and then transferred to an 1800 cc platinum crucible. The crucible is placed in a furnace at 1550° C., held at temperature for about 16 hours, then ramped at approximately 50° C./h to 1650° C., held for 4 hours, then poured into a square steel frame about 20 cm wide by 2 cm deep. Once the glass sets up, it is transferred to an annealer at 650° C., held for 1 hour, and then slowly cooled to room temperature. The square piece of glass is transferred to a ceramming furnace and subjected to the heat treatment described in Example 1, Table 2. Once cooled, the cerammed body is removed, cut to shape and polished. The ΔL/L vs. T curve for the ceramic is shown in FIG. 3.

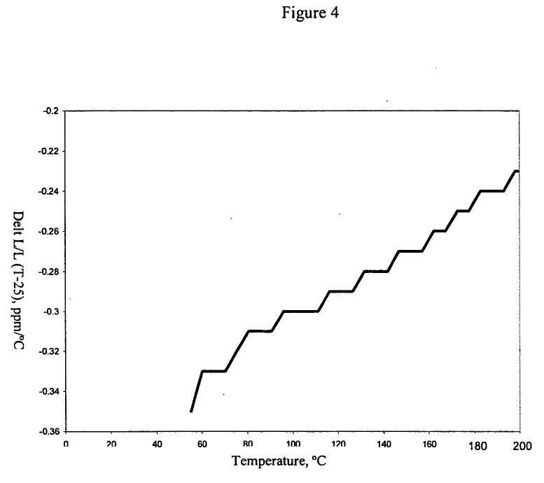

In comparing FIGS. 1-3, it is obvious that very low (in fact, slightly negative) expansions are obtained through use of the inventive ceramming process. Expressing the expansion coefficient as (ΔL/L)/(T-22), we find that CTE is approximately −0.2 to −0.3 from room temperature to 200° C. for all three glass-ceramics. An example of CTE vs. T is shown for the composition in Example 3 in FIG. 4. This shows that provided that the green glasses lie within the composition ranges shown in patents cited earlier, the CTE of the final ceramic is largely insensitive to the composition of the initial green glass.

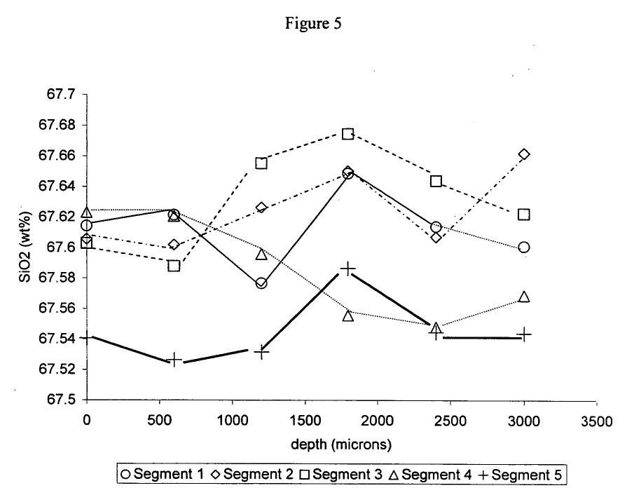

The importance of composition insensitivity cannot be understated. In production, the green glass would be obtained by direct melting of a coarse powder precursor. While modem melting methods result in substantially homogeneous glass on a scale of cubic centimeters or better, on a very fine scale it is typically possible to detect minor compositional variations throughout the glass. An example is shown in FIG. 5. A 15×15 cm plate of cerammed cerammed tank-melted KERALITE was cut into six 3×15 cm strips. Each strip was mounted on its edge in epoxy and microprobe analysis for SiO₂ was conducted through the length. For a given sample, variations in SiO₂ concentration corresponds to changes in composition through the thickness of the sample, while variations from sample-to-sample correspond to changes in composition across the width of the cheet. As can be seen from FIG. 5, the SiO2 varies both through the thickness of each sample and also from sample-to-sample of the tank-melt KERALITE. When the KERALITE material is cerammed according to methods known in the art, the resulting products have properties as shown in U.S. Pat. No. 5,070,045. However, when samples of the tank-melt material were cerammed according to the invention, the resulting product has the properties described herein. For example, a CTE of 0±0.5×10⁻⁷/° C. as opposed to a CTE of 0±3×10⁻⁷/° C. stated in U.S. Pat. No. 5,070,045. As a result, the product of the invention is suitable for ETVL applications whereas the product of U.S. Pat. No. 5,070,045, or U.S. Pat. No. 4,707,458, is not suitable for EUVL application because of their much higher CTE. Consequently, given the very similar results demonstrated in FIGS. 1-3 for very different bulk glass-ceramic compositions, it is obvious that minor variations of the magnitude shown in FIG. 5 will have no impact on the CTE of the final glass-ceramic prepared according to the invention.

Glass-ceramic composition prepared according to the invention were polished using different techniques, and the surface quality was measured and compared to other materials For EUVL applications polished surfaces should have a flatness over the entire surface of <1000 nm PV (PV=peak-to-valley) and a surface roughness of <0.20 nm rms over 10 μm spacing; and preferably with a surface roughness of <0.15 nm rms over a ten millimeter spacing. Two samples of the KERALITE material of Example 3 that were cerammed according to the invention were polished using standard polishing techniques that are optimized for polishing glass. It needs to be emphasized that the techniques were not optimized for polishing glass-ceramic materials. The polishing techniques used, while sophisticated, are pretty arbitrary. As those skilled in the art will know, the results shown below will improve when the polishing techniques are optimized for glass-ceramic materials.

TABLE 3
Polishing Results

| Sample | Technique | Surface Roughness (nm) | Comments |
|---|---|---|---|
| 1 | Spindle | 0.215 | Polishes Easily |
| 2 | Planetary Lap | 0.206 | Polished Easily |

The results, using a non-optimized technique developed for glass and not a glass-ceramic, indicate that a surface roughness of <0.2 nm rms will easily be achieved using an optimized polishing technique.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A glass-ceramic material suitable for use in the manufacturing of EUVL reflective optics, said glass-ceramic being made from a composition comprising (in wt. %):
SiO₂ 64-70
Al₂O₃ 18-24
Li₂O 1.6-3.8
MgO 0.8-1.5
ZnO 0.7-4.2
BaO 0-1.4
TiO₂ 2.0-3.5
ZrO₂ 1.25-2.5
As₂O₃ 0-1.0
Na₂O <0.5
K₂O <0.5
Wherein said glass-ceramic material has an aggregate coefficient of thermal expansion of 0±0.5×10⁻⁷/° C. in the temperature range 0-200° C.

2. The glass-ceramic material according to claim 1, wherein the slope of the CTE of said material is approximately 0.0 at 22° C.

3. The glass-ceramic material according to claim 1, wherein the cerammed material have dimension of up to 25 cm² with a thickness of up to 4 cm.

4. A method for preparing glass-ceramic materials suitable for EUVL applications, said method comprising the steps of:
(a) preparing a green glass composition comprised of:
SiO₂ 64-70
Al₂O₃ 18-24
Li₂O 1.6-3.8
MgO 0.8-1.5
ZnO 0.7-4.2
BaO 0.1-1.4
TiO₂ 2.0-3.5
ZrO₂ 1.25-2.5
As₂O₃ 0.1-1.0
Na₂O <0.5
K₂O <0.5
(b) milling the composition for a time in the range of 1-3 hours;
(c) transferring the milled composition to a vessel;
(d) placing the vessel in a furnace at a temperature of 1550±5° C. to melt the composition and holding the composition in the furnace for a time in the range of 14-18 hours;
(e) heating the melted composition to approximately 1650±10° C. and holding the composition at temperature for a time in the range of 3-6 hours;
(f) transferring the melt composition to a form and, once the melt has set, transferring the form containing the set melt to an annealing furnace at a temperature of 650±25° C. and holding at this temperature for a time in the range of 1-3 hours;
(g) slowly cooling the melt to room temperature;
(h) placing the cooled, annealed material to a ceramming furnace; and ceramming according to the schedule:

| Starting Temp | Final Temp | ramp rate | Hold Time |
|---|---|---|---|
| (° C.) | (° C.) | (° C./minute) | (Hours) |
| 18-50 | 720 ± 20 | 0.5 | ≧4 to 8 |
| 720 ± 20 | 820 ± 20 | 1 | ≧4 to 40 |
| 820 ± 20 | T | 0.1-0.05 | 0 |
| T | 22 | 0.2 | end |

T = 700 ± 30° C.
to thereby make a glass-ceramic material suitable for use in reflective EUVL applications.

5. The method according to claim 4, wherein the ceramming schedule is:

| Starting Temp. | Final Temp | ramp rate | |
|---|---|---|---|
| (° C.) | (° C.) | (° C./minute) | Hold (hours) |
| 22 | 720 | 0.5 | 4 |
| 720 | 820 | 1 | 20 |
| 820 | T | 0.1 | 0 |
| T | 22 | 0.2 | End |

T = 700 ± 30° C.

6. The method according to claim 5, wherein in the temperature range 820 to T ° C. the ramp rate is 0.05° C./minute.

7. A substrate suitable for use as a substrate to extreme ultraviolet lithographic reflective elements, said substrate comprising:
a cerammed material of composition
SiO₂ 64-70
Al₂O₃ 18-24
Li₂O 1.6-3.8
MgO 0.8-1.5
ZnO 0.7-4.2
BaO 0.1-1.4
TiO₂ 2.0-3.5
ZrO₂ 1.25-2.5
As₂O₃ 0.1-1.0
Na₂O <0.5
K₂O <0.5
wherein said cerammed material has a CTE of 0±0.5×10⁻⁷/° C.

8. The substrate according to claim 7, wherein said substrate, when polished, has a surface roughness of <0.2 nm rms.

9. The substrate according to claim 7, wherein said substrate, when polished, has a surface roughness of <0.15 nm rms.
